(19) United States
(12) Patent Application Publication
(10) Pub. No.: US 2014/0185295 A1
(43) Pub. Date: Jul. 3, 2014

(54) Decorative Light Display

(71) Applicants: Ronald G. Presswood, JR., Houston, TX (US); Selby Sullivan, Oviedo, FL (US)

(72) Inventors: Ronald G. Presswood, JR., Houston, TX (US); Selby Sullivan, Oviedo, FL (US)

(21) Appl. No.: 13/733,509

(22) Filed: Jan. 3, 2013

(51) Int. Cl. F21S 4/00; F21V 21/14

(52) U.S. Cl. CPC F21S 4/001
USPC 362/249.08; 362/396; 362/249.16

(57) ABSTRACT

A three-dimensional frame for use with decorative light displays and, more particularly, a frame on which lights can be stung that has frame members formed with snap-fit connector ends, which are connected together by intersection pieces that include a plurality of snap-fit connector receptacles for receiving the connector ends, for forming a frame that can easily be repaired, assembled and disassembled.

### CROSS REFERENCE TO RELATED APPLICATIONS

This application is a continuation-in-part of application Ser. No. 13/159,788 filed Jun. 14, 2011, incorporated by reference herein.

### BACKGROUND

1. Field of the Invention

This invention relates to a three-dimensional frame for use with decorative light displays and, more particularly, to a frame on which lights can be strung that has frame members formed with snap-fit connector ends, which are connected together by intersection pieces that include a plurality of snap-fit connector receptacles for receiving the connector ends, for forming a frame that can easily be repaired, assembled and disassembled.

2. Description of the Related Art

Current decorative light displays or designs are made to hold individual light strands in spherical, star or other shapes, such as a reindeer or a Christmas tree. Known designs may be made of a solid material with a light placed internally that illuminates the outer surface. Other displays are generally made of a solid framework, with the lights disposed in a string or strand wrapped around the periphery thereof.

Grapevines are also used in decorative light displays. Grapevines are collected from a vineyard, wrapped in the shape of a ball, and dried. Strings of lights are clipped or otherwise attached to the surface of the resulting ball. Grapevine balls, of course, pose a significant fire hazard, are particularly expensive, as they require a substantial investment in labor in the construction thereof, and involve an increased cost relating to the clips or other attachment methods used to attach the lights to the ball.

Styrofoam balls are also utilized as the foundation upon which light strands are attached. Styrofoam ball light displays must have the lights disposed on the exterior surface thereof, and are unable to have a light disposed in the interior. Thus, Styrofoam balls cannot be used to form lamp-like structures. As noted above with respect to grapevine balls, additional costs are also associated with the clips or other attachment methods needed to attach the lights to the ball.

Rigid metal hoops are also assembled to form frameworks upon which light strands may be draped. Such hoops are quite heavy and are relatively expensive, as extensive metal fabrication is required to make the hoops. The outer circumference of known metal displays is smooth. The smooth outer circumference permits the light strands wrapped thereon to slide off or dangle freely, thus creating an unattractive appearance.

It is often difficult to transport and store known displays to and from storage, as they are frequently large and delicate, requiring great care in handling. In addition, large, uneconomical spaces are needed to store such displays when not being used.

It is difficult to repair or replace lights in the light string of known decorative light displays, as the light strands disposed thereon often become tangled and require extensive man hours to remove the attached lights from the clipping or attachment method used.

Earlier versions of the invention used flexible interlocking substructures for forming a framework, which were circular or square shaped, and were assembled using an interlocking design to form the framework. Although these substructures were an improvement over the prior art, they were relatively large and could be difficult to assemble and dissemble.

### SUMMARY OF THE INVENTION

In accordance with the present invention, an improved display framework is formed of interlocking frame members which can be assembled into a three-dimensional shape. The display framework includes a plurality of frame members which, when assembled, form a three-dimensional shape. Each frame member has at least two first snap-fit connector sections.

A plurality of intersection pieces are used for connecting the frame members. The intersection pieces include a plurality of second snap-fit connector sections.

The first and second snap-fit connector sections are shaped and dimensioned to cooperate with each other to form a releasable snap-fit connection between the frame members and the intersection pieces.

The frame members and intersection pieces are formed of molded plastic or are machined from a suitable material.

The first snap-fit connector sections each include at least one flexible cantilevered arm. The second snap-fit connector sections each include a receptacle for receiving and releasably holding the first snap-fit connector sections.

The intersection pieces can include four receptacles extending outwardly in the same plane 90 degrees from each other.

The frame members can be curved so that when they are connected through the intersection pieces they can form a sphere.

The frame members can be linear so that when they are connected through the intersection pieces they can form a rectilinear three-dimensional shape.

The frame members can have a wavy design formed on along one side for contacting a decorative string of lights.

The wavy design can be selected from the group consisting of a sinusoidal wave shape, a rectangular wave shape, and a square wave shape.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows four curved frame members of the decorative light display arranged in the shape of a circle;

FIG. 1A is a close-up view of a snap-fit connector section of one of the frame members shown in FIG. 1;

FIG. 2 is a top view of an intersection piece for connecting the frame members.

FIG. 3 is a side view of the intersection piece of FIG. 2.

FIG. 4 shows frame members of FIG. 1 connected to the intersection piece through their respective snap-fit connectors.

FIG. 5 shows a sphere formed by using the curved frame members in FIG. 1 and connector sections in FIGS. 2-4.

FIG. 6 shows the sphere in FIG. 5 with decorative lights wrapped around it.

FIG. 7 shows four linear frame members of the decorative light display arranged in the shape of a square.

FIG. 8 shows a cube formed by using the linear frame members in FIG. 7 and connector sections in FIGS. 2-4.

FIG. 9 shows a display in the shape of a Christmas tree made up of frame members of different shapes which can be connected through connector sections.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

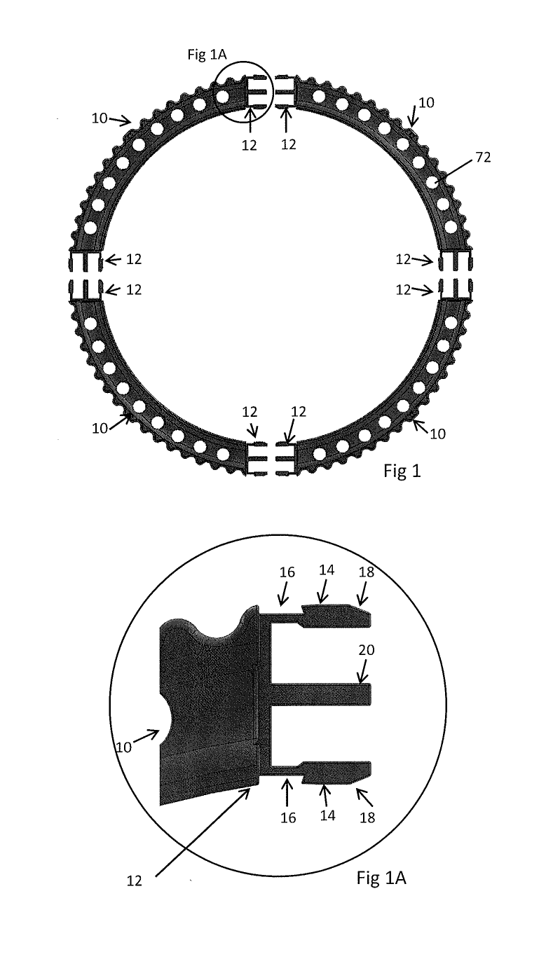

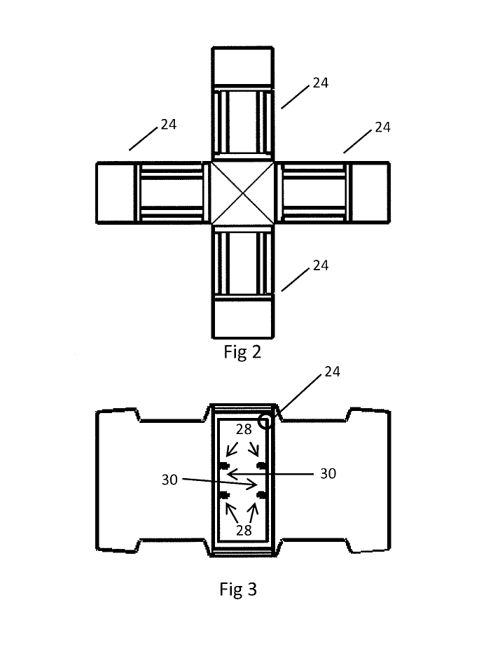

Referring to the drawings, and initially to FIG. 1 thereof, four curved frame members 10 are shown. Each frame member 10 extends through a 90° arc so that when they are arranged as shown in FIG. 1 they will form a complete circle. A snap-fit connector end 12 is formed at the ends of each frame section. The snap-fit connector ends 12 include two cantilevered prongs 14, which have a narrowed neck 16 that allows the prongs 14 to flex inwardly when the cam surface 18 engages and slides along a rigid surface on a cooperating snap-fit receptacle (see FIGS. 2 and 3), and then spring or snap back to their original position to lock the snap-fit connector end 12 into place, as discussed in greater detail below. Each snap-fit connector end 12 also includes a projection 20, which guides the prongs 14 into proper alignment when they are inserted into the cooperating snap-fit receptacle.

The frame members 10 are preferably formed of molded plastic with the snap-fit connector ends 12 formed as an integral part of each frame member. Molded plastic provides the frame members with sufficient rigidity and at the same allows the cantilevered prongs to be flexible enough to work as described. However, other suitable materials can be used for the frame members, such as for example metal, and the snap-fit connector ends 12 can be attached to the separately formed frame members.

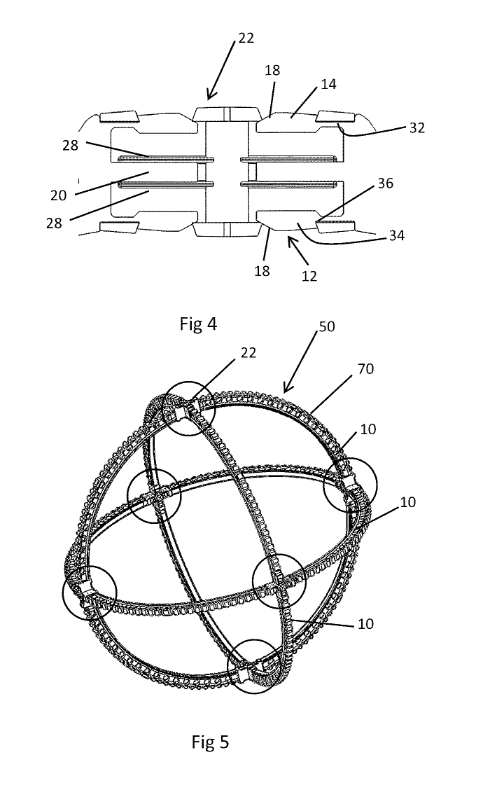

The frame members 10 are connected together with intersection pieces 22 of the type shown in FIGS. 2 and 3. The intersection pieces 22 have four snap-fit sections 24 in the form of receptacles for receiving the snap-fit connector ends 12, which are formed at 90° from each other. Each receptacle includes a socket 26 with an open end for receiving a snap-fit connector end 12. The sockets have two pairs of internal ridges 28, which form a channel 30 to receive and guide the projection 20 as the snap-fit connector end 12 is inserted into the receptacle 26. As shown in FIG. 4, the receptacles also include internal surfaces 32 which are engaged by the cam surfaces 18 for pushing the cantilevered prongs 14 inwardly as the snap-fit connector end 12 is inserted into the receptacle 26, and side openings 34 through which the cantilevered prongs 14 will snap into after the prongs are inserted to the position shown in FIG. 5. The ledge 36 on each prong 14 engages the surface which defines the opening 34 for locking the snap-fit connector end 12 in place. Disassembly of the snap-fit connection can be accomplished by pressing inwardly in the prongs 14 on both sides of the receptacle 26, which allows the snap-section 12 to be withdrawn from the receptacle 26.

Although the snap-fit connections in FIGS. 1-4 are of the two-prong cantilevered type, there are many other types of known snap-fit connections that could also be use in conjunction with the invention. Such connections include but are not limited to cantilevered connectors with a single cantilevered prong or spherical snap-fit connectors.

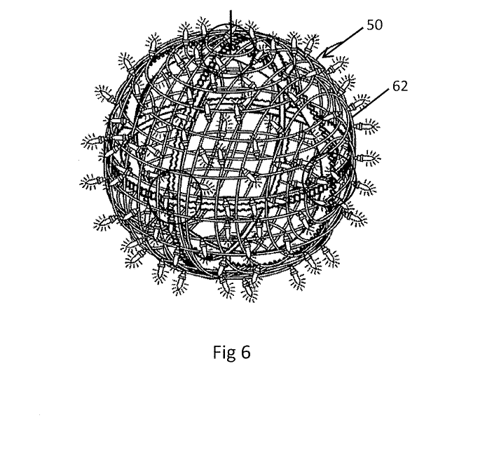

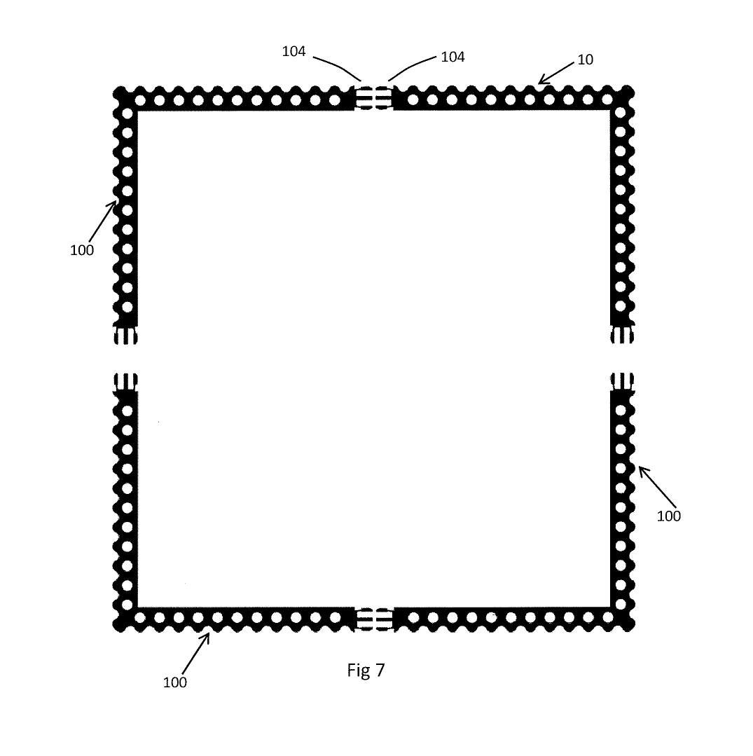

The frame sections 10 and intersections 22 can used to form a sphere 50 as shown in FIG. 5, which can be used to display decorative lights 60 in a manner illustrated in FIG. 6. In order to provide guides or channels for the wires of the lights, the frame members include a wavy or toothed design or shape on their outer surface, which is referenced by numeral 70 in FIGS. 1 and 5. The wavy or toothed shape creates a surface that retains or secures the light strand wires 62 thereto, and yet prevents the light strand wires 62 from bunching together when they are wrapped around the spherical decorative light display. The light strand wires 62 are retained on the wavy surface 70 of the frame member 10 using the tension force of the light strand wires 62. It will be appreciated by those of skill in the art that no other mechanical retention device or mechanism, such as a clip or the like, is needed to secure the light strand wires 62 in contact with the outer circumference of the frame members 10. As illustrated in FIG. 7, the light strand wires 62 are wrapped around the frame members 10 so that the wavy or toothed shape 70 engages the light strand wire 62 and prevents the same from sliding or falling off the frame members 10.

Any wavy shape 70 may be utilized in the present invention, or a combination thereof. In the preferred embodiment, a sinusoidal wave shape 70 (see FIG. 1) is formed in the outer circumference of the frame members 10. It will be appreciated that the amplitude and frequency of the sinusoidal function must be carefully selected. If the amplitude or the frequency of the wavy shape 70 is too large, the light strands 62 will bunch together at the bottom of the sphere 50. If the amplitude or frequency of the wavy shape 70 is too small, there may not be sufficient force to retain the light string 62 in contact therewith. Other designs, such as a square wave or a rectangular wave (not shown) may be used, but must have sufficient dimensions to prevent the light strands 62 from bunching together while providing sufficient force to retain the light strands 62 in contact with the frame members 10.

It will be appreciated that the frame members 10 may be formed with openings 72 in them (see FIGS. 1). The openings 72 are formed so as to reduce the material used in the fabrication thereof, and therefore, reduce the costs of production. Additionally, when the frame members 10 are formed by an extrusion process, they will cool down faster when the openings 72 are formed therein, which permits faster production of the frame members. The frame members 10 may be of various dimensions or diameters depending upon the desired shape of the decorative light display.

It will be appreciated by those of skill in the art that other decorative display shapes may be formed. The shape may also be, for example, egg-shaped, a cube, a rectangular solid, crown, or a cone.

FIG. 7, for example, illustrates frame members 100 that can used to form a cube-shaped three-dimensional frame 102. As in the case of the embodiment shown in FIGS. 1-6, utilizing the circular-shaped frame members 10, discussed hereinbefore, the frame member 100 is formed with two legs oriented at 90° relative to each other, which have a wavy surface shape on their outer surface. The frame members 100 have snap-fit connector ends 104 on each end, which can be inserted into snap-fit receptacles formed in intersection pieces, similar to those described for the embodiment shown in FIGS. 1-6.

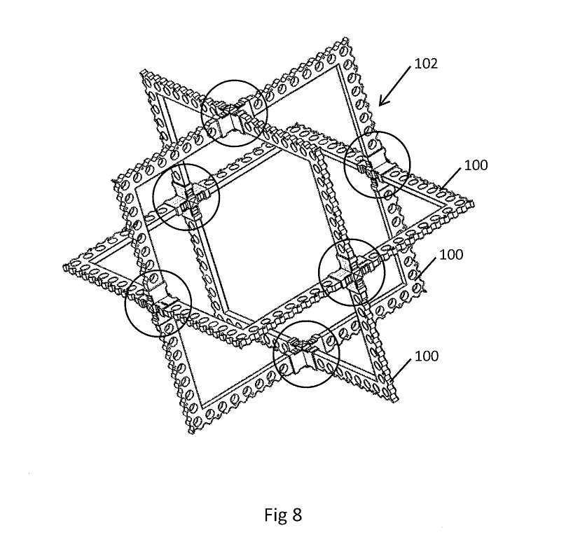

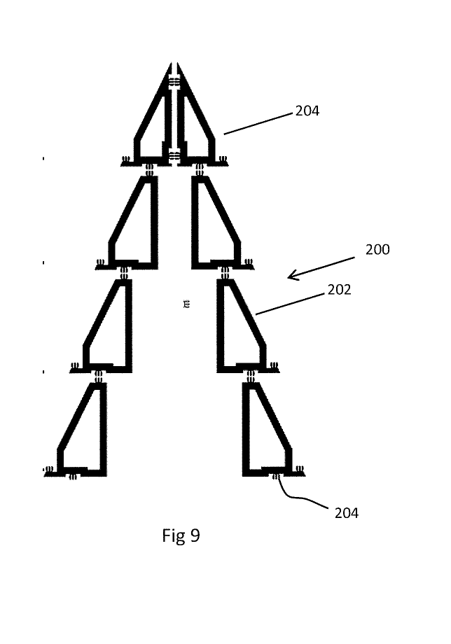

As shown in FIG. 8, the frame members 100 can be connected to form a cube-shaped three-dimensional display frame on which decorative lights can be mounted as described above in connection with FIG. 6. Alternatively, instead of providing frame members with 100 two legs as shown in FIG. 7, the frame members can be formed as straight pieces with snap-fit connector ends at each end, which can be connected by an intersection piece having two snap-fit receptacles.

FIG. 9 shows a two-dimensional Christmas tree shaped display 200 formed of frame members 202 with snap-fit connector ends 204 formed on the frame members 202. The frame members 202 can be connected together with snap-fit receptacles as described above. The display 200 is illustrative of the many different types of display shapes that can be formed by using the frame member sand receptacles of the present invention.

It is envisioned that the present invention may be manufactured from plastic material on a Computed Numerically Controlled Machine (“CNC”) machine, such as a CNC laser cutting machine, a CNC water jet cutting machine, a CNC router or the like. Injection molding, vacuum molding, or similar forming methods will also be suggested to those of skill in the art. Additionally, the invention may also be constructed by hand using a band or jig saw or a hand router. As noted hereinbefore, the frame members and intersection pieces may be manufactured using PVC or ABS polymers. The structures may also be made from any polymer, plastic, wood, or composite material, as well as recycled fibers such as fiber board, all as desired by persons of skill in the art.

It will be appreciated that the method and structure of the present invention provide unique advantages over known art displays. The structures are easily assembled, disassembled and stored, and the light strand wires may be easily attached, repaired and removed. It will also be appreciated that other decorative strings or strands may be used in conjunction with the three-dimensional frames such as beads, ribbons, garlands, Mylar sheets or the like that do not necessarily emit light, and the invention would function in the above-described manner just as it does with the light strand wires. In addition, a light may be placed within the three-dimensional frames, forming a lamp-like light source.

The foregoing description of embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A display framework formed of interlocking frame members which can be assembled into a three-dimensional shape, comprising:
a. a plurality of frame members which, when connected, can form said three-dimensional shape, each member having at least two first snap-fit connector sections;
b. a plurality of intersection pieces for connecting said frame members, said intersection pieces comprising a plurality of second snap-fit connector sections, said first and second snap-fit connector sections being shaped and dimensioned to cooperate with each other to form a releasable snap-fit connection between said frame members and said intersection piece.

2. The display framework of claim 1, wherein the frame members and intersection pieces are formed of molded plastic.

3. The display framework of claim 1, wherein said first snap-fit connector sections are comprised of at least one flexible cantilevered arm, and said second snap-fit connector sections are comprised of a receptacle for receiving and releasably holding said first snap-fit connector sections.

4. The display framework of claim 3, wherein the intersection pieces comprise four receptacles extending outwardly in the same plane 90 degrees from each other.

5. The display framework of claim 1, wherein the frame members are curved so that when they are connected through said intersection pieces they can form a sphere.

6. The display framework of claim 1, wherein the frame members are linear so that when they are connected through said intersection pieces they can form a rectilinear three-dimensional shape.

7. The display framework of claim 1, wherein said frame members have a wavy design formed on along one side for contacting a decorative string of lights.

8. The display framework of claim 7, wherein said wavy design is selected from the group consisting of a sinusoidal wave shape, a rectangular wave shape, and a square wave shape.

9. A decorative light display used with a decorative light string comprising: an inner flexible substructure, a middle flexible substructure, and an outer flexible substructure, said flexible substructures including an interlocking mechanism allowing said substructures to be assembled together to form a framework, said flexible substructures supporting said decorative light string in contact therewith.

10. The decorative light display of claim 17; wherein said interlocking mechanism is a pair of interlocking notches formed on cooperating surfaces of said flexible substructures.

11. The decorative light display of claim 18; and further comprising a plurality of protrusions formed on said substructures for contacting said light string.

12. The decorative light display of claim 19; wherein said protrusions comprise a wavy surface.

13. The decorative light display of claim 20; wherein said wavy surface is selected from the group consisting of a sinusoidal wave shape, a rectangular wave shape, and a square wave shape.

14. A decorative light display used with a decorative string of lights comprising:
a plurality of frame members which, when connected, can form said three-dimensional shape, each member having at least two first snap-fit connector sections;
a plurality of intersection pieces for connecting said frame members, said intersection pieces comprising a plurality of second snap-fit connector sections, said first and second snap-fit connector sections being shaped and dimensioned to cooperate with each other to form a releasable snap-fit connection between said frame members and said intersection piece.
said frame members having inner and outer surfaces, wherein the outer surface is formed with a series of indentations of for securing said decorative string of lights in contact therewith.

15. A decorative light display used with a decorative string of lights comprising:
a plurality of frame members which, when connected, can form said three-dimensional shape, each member having at least two first snap-fit connector sections;
a plurality of intersection pieces for connecting said frame members, said intersection pieces comprising a plurality of second snap-fit connector sections, said first and second snap-fit connector sections being shaped and dimensioned to cooperate with each other to form a releasable snap-fit connection between said frame members and said intersection piece.
said frame members holes cut into the structure to allow decorative string of lights or rope light to pass through said holes.
